(19) United States
(12) Patent Application Publication
(10) Pub. No.: US 2025/0069830 A1
(43) Pub. Date: Feb. 27, 2025

(54) MOLDED CASE CIRCUIT BREAKER

(71) Applicant: LS ELECTRIC CO., LTD., Anyang-si, Gyeonggi-do (KR)

(72) Inventors: Kihwan OH, Anyang-si, Gyeonggi-do (KR); Kyunghwan OH, Anyang-si, Gyeonggi-do (KR)

(21) Appl. No.: 18/726,226

(22) PCT Filed: Jan. 2, 2023
(86) PCT No.: PCT/KR2023/000042

§ 371 Date: Jul. 2, 2024

(30) Foreign Application Priority Data
Jan. 13, 2022 (KR) 10-2022-0005431

(51) Int. Cl. H01H 33/04; H01H 33/53

(52) U.S. Cl. CPC H01H 33/04; H01H 33/53

(57) ABSTRACT

The present disclosure relates to a wiring circuit breaker and, more specifically, to a wiring circuit breaker having an expanded arc gas discharging port formed through a lower part of an enclosure and thus having enhanced exhaust performance. A wiring circuit breaker according to an embodiment of the present disclosure comprises: an enclosure for the wiring circuit breaker; a base assembly coupled to the inside of the enclosure; an exhaust duct connected to an exhaust part of the base assembly; and a terminal part mount coupled to a terminal part of the enclosure and connected to the exhaust duct, wherein a center part exhaust groove is formed on the exhaust duct, and a center part exhaust hole communicating with the center part exhaust groove is formed through the terminal part mount.

### CROSS-REFERENCE TO RELATED APPLICATIONS

This application is the National Stage filing under 35 U.S.C. 371 of International Application No. PCT/KR2023/000042, filed on Jan. 2, 2023, which claims the benefit of earlier filing date and right of priority to Korean Application No. 10-2022-0005431, filed on Jan. 13, 2022, the contents of which are all hereby incorporated by reference herein in their entirety.

### FIELD

The present disclosure relates to a circuit breaker and, more particularly, to a circuit breaker having an expanded arc gas discharging port disposed through a lower part of an enclosure and thus having enhanced exhaust performance.

### BACKGROUND

Generally, a molded case circuit breaker (MCCB) is an electrical device configured to protect a circuit and a load by automatically breaking the circuit in a state of an electrical overload or a short circuit accident.

The MCCB largely includes a terminal part capable of being connected to a power source side or a load side, a contact part including a fixed contactor and a movable contactor to be in contact with or separate from the fixed contactor to connect or disconnect a circuit, an opening/closing mechanism configured to provide power needed to open/close the circuit by moving the movable contactor, a trip unit configured to induce a trip operation of the opening/closing mechanism by detecting overcurrent or short circuit current flowing on the circuit, and an arc extinguishing unit configured to extinguish an arc that occurs when abnormal current is blocked.

FIG. 1 illustrates a circuit breaker in the related art. FIG. 2 illustrates an internal structure of the circuit breaker in the related art, as cut along a longitudinal direction. FIG. 3 is a detailed view of an exhaust duct part of FIG. 2.

A circuit breaker 10 in the related art includes fixed contactors 1 and a movable contactor 2 both constituting a contact part disposed to connect or disconnect a circuit through which current transmitted from a power source side to a load side, an opening/closing mechanism part 4 configured to provide power capable of rotating the movable contactor 2, an arc extinguishing unit 3 disposed to extinguish an arc that occurs when fault current is blocked, a trip unit 5 configured to detect abnormal current and trip the opening/closing mechanism, etc., each in enclosures made of an insulating material and including a case 11 and a cover 12.

Additionally, a terminal part 9 is disposed in both end portions of the enclosures 11 and 12 to connect a circuit to a power source or a load.

Meanwhile, the contact parts 1 and 2 and the arc extinguishing unit 3 are separately mounted in an enclosure 8 (often briefly referred to as a base) of a base assembly disposed inside the case 11.

When fault current flows in the circuit, the trip unit 5 detects the fault current and performs a trip operation for operating the opening/closing mechanism part 4 to separate the movable contactor 2 from the fixed contactors 1 to block flow of current. At this time, an arc A is generated in the contact parts 1 and 2.

In this case, a size (intensity) of the arc is proportional to a size of the current. An arc refers to a phenomenon in which a gas in an atmosphere instantly reaches a plasma state due to a voltage. A center of the arc reaches a temperature 8,000 to 12,000° C., and has an explosive expansion pressure. Thus, since the contact parts 1 and 2 may be melted and consumed, thereby deteriorating and destroying peripheral components. Thus, whether the arc is continued may greatly affect performance and durability of a circuit breaker. Accordingly, the arc needs to be blocked, extinguished, and discharged quickly in the arc extinguishing unit 3.

As such, in a case when fault current occurs in the circuit breaker, arc handling work becomes a main goal of blocking the fault current to protect a product, a load, and wires. This directly affects performance of the circuit breaker.

When the fault current is obstructed, an operation of the base assembly is performed as described below.

When the fault current occurs, the opening/closing mechanism part 4 operates according to operation of the trip unit 5, and accordingly, a shaft 6 rotates clockwise. At this time, an arc is generated at the contact parts 1 and 2, and the arc is cooled in a split method and extinguished while moving to grids 3a in the arc extinguishing unit 3 (an arc chamber). As the arc moves along the grids 3a, an arc voltage increases, and eventually the arc becomes extinct.

In the circuit breaker, a success in circuit breaking depends on quick arc extinguishing. That is, a rotation speed of the shaft 6 needs to be high, and the generated arc needs to spread fast to the grids 3a to increase an arc voltage.

When the arc A is generated in the contact parts 1 and 2 due to occurrence of fault current, the arc A passes between the grids 3a in the arc extinguishing unit 3 and exits through an exhaust port 8-1 in the base 8.

Then, the arc passes through an exhaust duct 14 under the terminal part 9 and passes through a mount 15.

FIG. 4 is a perspective view of the case 11 of the circuit breaker in the related art. This drawing illustrates the case 11 as viewed obliquely from above towards a power source side.

A pair of terminal part exhaust pipes 13 are disposed in each phase. The mount 15 is fit into a body part 13-2 of the exhaust pipes 13, and a space between inlets of the exhaust pipes 13 is a portion adjacent to the exhaust duct 14 and blocked by a partition wall 13-1.

FIGS. 7 and 8 illustrates the mount 15 and the exhaust duct 14.

An insertion groove 15-1 on both side surfaces of the mount 15 is fit into the body part 13-2 of the exhaust pipes 13.

The exhaust duct 14 guides arc gas flowing from the exhaust port 8-1 in the base 8 to the exhaust pipes 13 of the terminal part 9. The exhaust duct 14 is directly connected to the exhaust port 8-1. The arc gas passes through the exhaust duct 14, is split by a branch port 14-1, and flows into the exhaust pipes 13 arranged on both sides, respectively, in each phase.

FIGS. 5 and 6 illustrate this arc exhaust process. FIG. 5 illustrates a state in which a lower surface portion of the circuit breaker is cut and viewed upwardly from a bottom. FIG. 6 is a detailed view of the exhaust hole of FIG. 5.

A process in which the arc A generated when the contact parts 1 and 2 are blocked exits through the exhaust pipes 13 of the terminal part via the exhaust port 8-1 and the exhaust duct 14 in the base 8 is illustrated.

However, in the circuit breaker in the related art, since an arc pressure exhaust structure is equipped with a mount for fastening a terminal in the terminal part, the branch port 14-1 is disposed in the exhaust duct 14 to avoid the mount 15 for each phase. That is, an arc flows through the branch port 14-1 in the exhaust duct 14 to diverge into the exhaust pipes 13 on both sides of the terminal part.

Thus, as shown in detail in FIGS. 5 and 6, in a final portion of the exhaust pipes, the arc discharging port uses only about ⅔ of a space. Therefore, an arc pressure may stagnate inside the branch port, and the stagnant arc pressure may increase an internal pressure of a product, thereby causing a damage to the product.

### SUMMARY

Therefore, to obviate those problems, an aspect of the detailed description is to provide a circuit breaker having an expanded arc gas discharging space to have enhanced arc exhaust performance.

According to one aspect of the present disclosure, there is provided a circuit breaker including: an enclosure for the circuit breaker; a base assembly installed in the enclosure for each phase; an exhaust duct connected to an exhaust port in the base assembly; and a terminal part mount coupled to a terminal part of the enclosure and connected to the exhaust duct, wherein a center part exhaust groove is disposed in the exhaust duct, and a center part exhaust hole communicating with the center part exhaust groove is disposed through the terminal part mount.

Here, a pair of terminal part exhaust pipes through which an arc gas is discharged may be disposed in the terminal part for each phase, the terminal part mount may include a support disposed between the pair of terminal part exhaust pipes, and the center part exhaust hole directing from inside toward outside of the enclosure may be disposed in the support.

In addition, the enclosure may be equipped with a through hole disposed in a partition wall between the pair of terminal part exhaust pipes.

In addition, a guide wall having a curved front surface part may be disposed above the central part exhaust hole.

In addition, a portion of an upper surface of the exhaust duct, the portion being connected to the exhaust port, may be disposed as a curved surface portion.

In addition, after the curved surface portion is disposed, a first step portion and a second step portion a portion may be disposed on the upper surface of the exhaust duct.

In addition, a branch port having two leg portions may be disposed in a rear portion of the exhaust duct, and a space between the two leg portions may be the center part exhaust groove.

In addition, a roof portion having a ‘V’ shape or a ‘U’ shape may be disposed on the two leg portions.

In addition, a plurality of cut grooves may be disposed in an upper surface part of the exhaust duct.

According to another aspect of the present disclosure, a circuit breaker including: an enclosure; a base assembly included in the enclosure for each phase; an exhaust duct connected to an exhaust port in the base assembly; and a terminal part mount coupled to a terminal part of the enclosure and connected to the exhaust duct, wherein a through hole is disposed between a pair of terminal part exhaust pipes located on the terminal part, a center part exhaust groove communicating with the through hole is disposed in the exhaust duct, and a center part exhaust hole communicating with the center part exhaust groove is disposed through the terminal part mount.

In a circuit breaker according to one embodiment of the present disclosure, an exhaust passage for discharging arc gas is further disposed between terminal part exhaust pipes, thereby preventing a delay in discharging exhaust pressure.

A through hole is disposed in a partition wall portion between terminal part exhaust pipes to communicate with a center part exhaust groove in an exhaust duct and a center part through hole in a terminal part mount. Accordingly, a center part arc discharging path between exhaust pipes may be defined.

When arc gas flows out of an exhaust port in a base assembly, a portion closed until the arc gas is discharged to outside is minimized. Thus, discharging may be facilitated without waste of a space.

Accordingly, a phenomenon in which the arc gas stagnates in the exhaust port may be reduced.

Accordingly, a phenomenon in which a pressure increases in a product may be prevented, and a damage to an enclosure for the product may be prevented.

### BRIEF DESCRIPTION OF THE DRAWINGS

FIG. 1 illustrates a circuit breaker in the related art.

FIG. 2 illustrates an internal structure of the circuit breaker in the related art, as cut along a longitudinal direction.

FIG. 3 is a detailed view of an exhaust duct part of FIG. 2.

FIG. 4 is a perspective view of a case of the circuit breaker in the related art.

FIG. 5 is a bottom perspective view of the circuit breaker in the related art, in which a bottom surface is cut.

FIG. 6 is a detailed view of an exhaust hole portion of FIG. 5.

FIG. 7 is a perspective view of a mount applied to the circuit breaker in the related art.

FIG. 8 is a perspective view of an exhaust duct applied to the circuit breaker in the related art.

FIG. 9 illustrates an internal structure of a circuit breaker according to one embodiment of the present disclosure, as cut along a longitudinal direction.

FIG. 10 is a perspective view of an arc distinguishing unit applied to the circuit breaker according to one embodiment of the present disclosure.

FIG. 11 is a detailed view of an exhaust duct part of FIG. 9.

FIG. 12 is a perspective view of a case of the circuit breaker according to one embodiment of the present disclosure.

FIG. 13 is a detailed view of an exhaust port and a terminal part of the circuit breaker according to one embodiment of the present disclosure, as viewed from a lower surface with a bottom surface cut away.

FIG. 14 is a perspective view of a mount applied to the circuit breaker according to one embodiment of the present disclosure.

FIG. 15 is a perspective view of an exhaust duct applied to the circuit breaker according to one embodiment of the present disclosure.

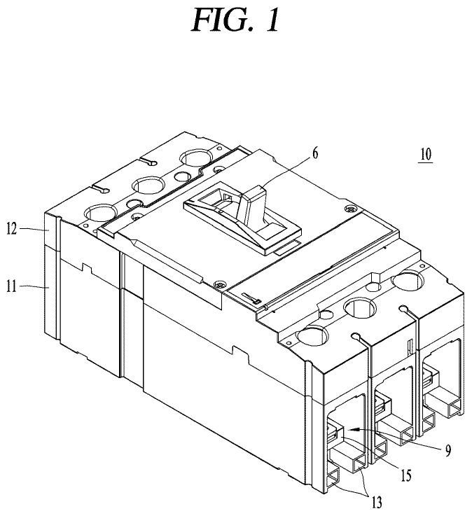

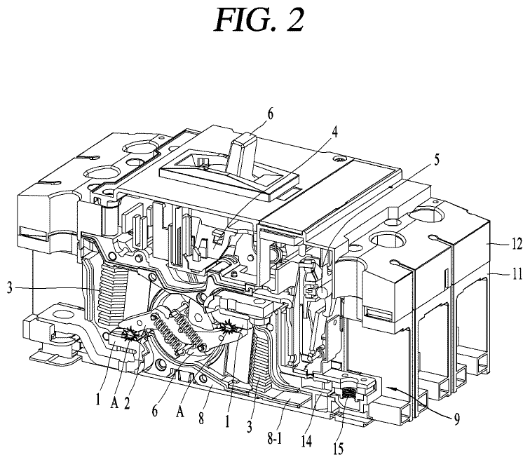

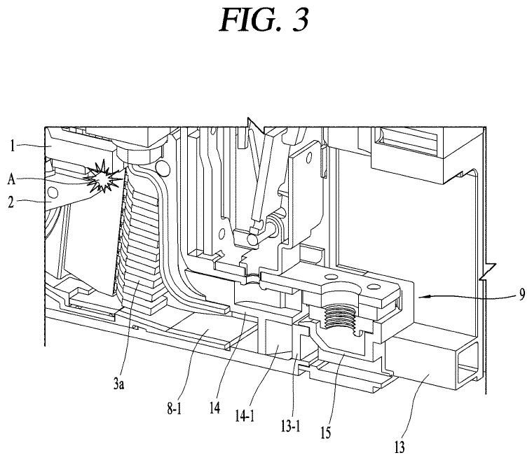

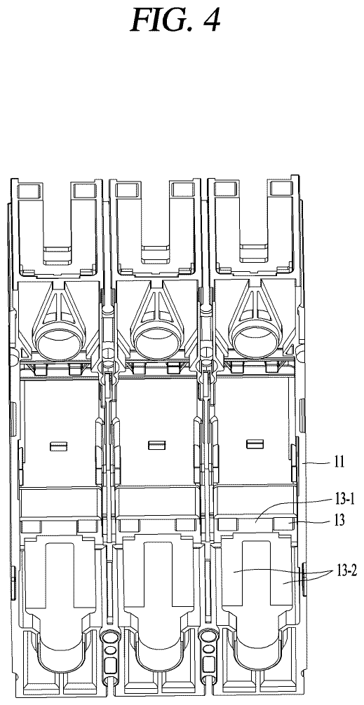

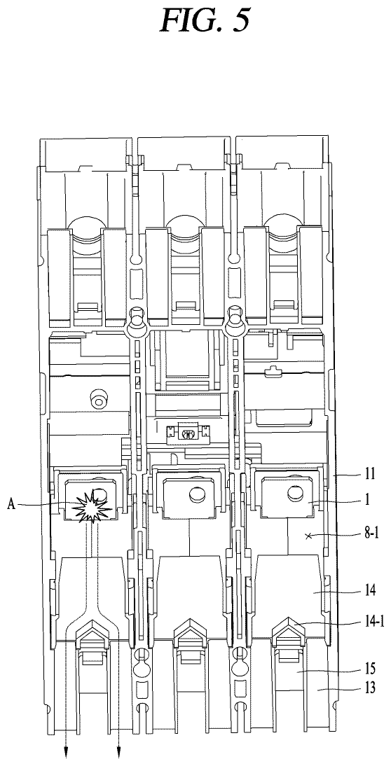

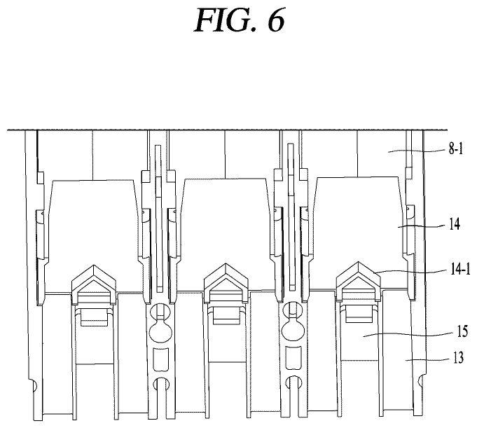

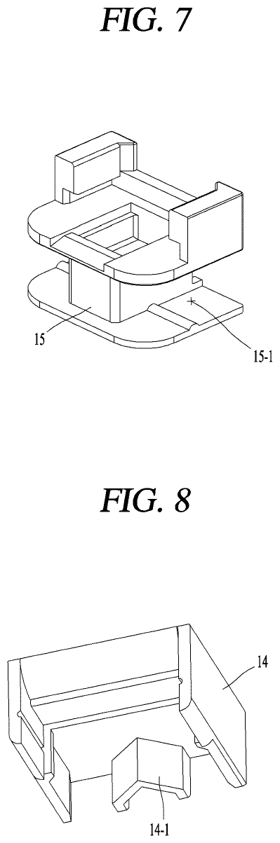

### DETAILED DESCRIPTION

Hereinafter, embodiments of the present disclosure are described with reference to the accompanying drawings. However, this is intended to provide a detailed description so that those of ordinary skilled in the art can easily implement the disclosure, and the technical idea and scope of the present disclosure are limited by the accompanying drawings.

The term “member,” “unit,” or “part” used herein is to indicate components in the present disclosure are not used for any purpose of limitation, and may be omitted.

A circuit breaker according to respective embodiments of the present disclosure will be described in detail with reference to the accompanying drawings.

The circuit breaker according to one embodiment of the present disclosure includes: enclosures 101 and 102 of the circuit breaker; a base assembly 110 coupled to inside of the enclosures 101 and 102; an exhaust duct 170 connected to an exhaust port 149 of the base assembly 110; and a terminal part mount 180 coupled to a terminal part 109 of the enclosures 101 and 102 and connected to the exhaust duct 170, wherein a center part exhaust groove 176 is disposed in the exhaust duct 170, and a center part exhaust hole 186 communicating with the center part exhaust groove 176 is disposed through the terminal part mount 180.

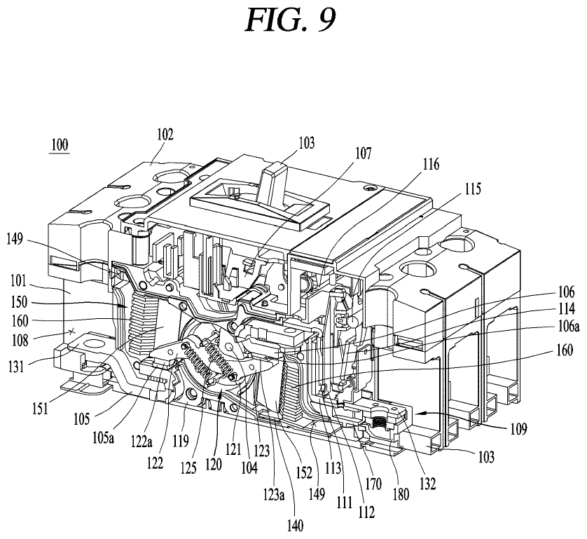

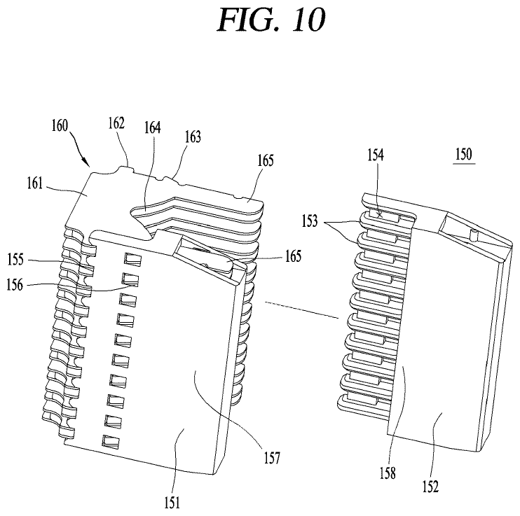

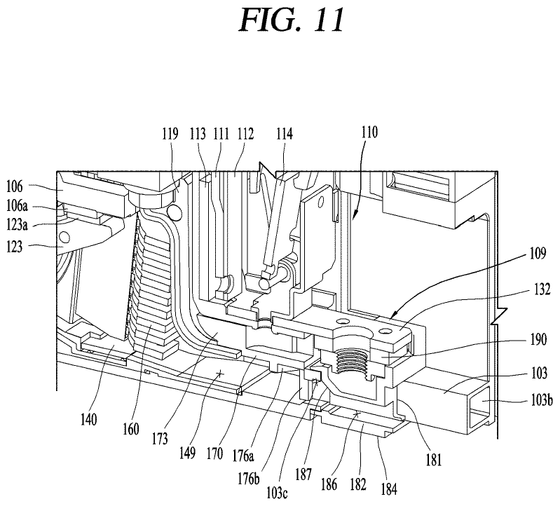

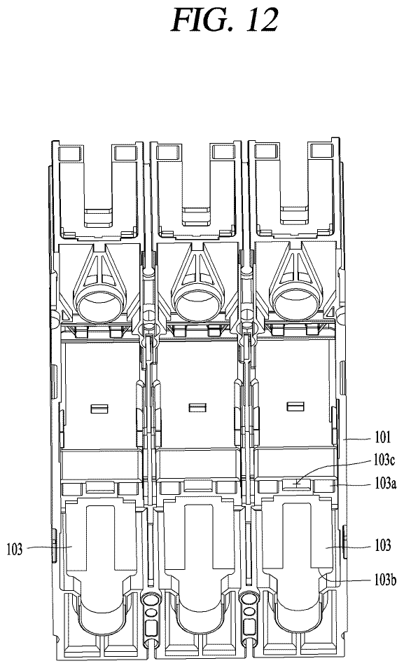

FIG. 9 illustrates an internal structure of the circuit breaker according to one embodiment of the present disclosure, as cut along a longitudinal direction. FIG. 10 is a perspective view of an arc distinguishing unit applied to the circuit breaker according to one embodiment of the present disclosure. FIG. 11 is a detailed view of an arc exhaust part of FIG. 9. FIG. 12 is a perspective view of cases of the enclosures for the circuit breaker according to one embodiment of the present disclosure, as viewed from above.

The enclosures 101 and 102 accommodate and support components of the circuit breaker. The enclosures 101 and 102 are configured to have approximately a box shape. A handle 107a is exposed on an upper surface of the enclosures 101 and 102. The handle 107a operates an opening/closing mechanism 107 by manual manipulation force by a user.

The enclosures 101 and 102 are made of an insulating material. The enclosures 101 and 102 may include a case 101 disposed in a lower portion thereof and a cover 102 covering an upper portion of the case.

Terminal units 108 and 109 capable of being connected to a power source or a load are disposed on front and rear surfaces of the enclosures 101 and 102. The terminal parts 108 and 109 include the terminal part 108 on a power source side and the terminal part 109 on a load side.

The terminal parts 108 and 109 are disposed for each phase (or each pole). For example, in a case of a three-phase circuit breaker, three terminal parts may be disposed on a power source side and a load side, respectively.

The terminal parts 108 and 109 are equipped with terminals 131 and 132, respectively. The terminal part 108 on the power source side is equipped with a power source side terminal 132 connected to a power circuit, and the terminal part 109 on the load side is equipped with a load side terminal 131 in a load circuit. The terminals 131 and 132 are connected to fixed contactors 105 and 106, respectively.

Terminal part exhaust pipes 103 through which arc gas is discharged to outside are disposed in lower end portions of the terminal parts 108 and 109, respectively. The terminal part exhaust pipes 103 are located at both sides, respectively, for each phase. Each of the terminal part exhaust pipes 103 may be in contact with a terminal part exhaust pipe 103 in an adjacent phase.

In the terminal part exhaust pipes 103, exhaust holes 103a and 103b are disposed along a longitudinal direction of pipes. Along entry and exit paths of arc, an inside hole inlet is referred to as an exhaust hole inlet 103a, and an outside hole outlet is referred to as an exhaust hole outlet 103b to be distinguished from each other. The exhaust hole inlet 103a is a portion connected to the exhaust duct 170, and the exhaust hole outlet 103b is a portion connected to outside of the enclosures 101 and 102.

Referring to FIG. 12, in the terminal part 109 on the load side, a through hole 103c is disposed in a partition wall (no reference numeral) between exhaust hole inlets 103a in a pair of the terminal part exhaust pipes 103 included in each phase. Arc gas flowing out of the exhaust port 149 may be also discharged to outside through the through hole 103c.

A trip unit 110 configured to detect abnormal current flowing in a circuit and trip an opening/closing mechanism is generally equipped in a part of the enclosures 101 and 102. The trip unit is generally disposed on the load side.

The trip unit includes a heater 111 connected to the terminal part 109 on the load side, a bimetal 112 coupled to the heater 111 to detect heat and be curved according to amount of heat, a magnet 113 and an armature 114 each installed in a periphery of the heater 111, a crossbar 115 installed to be rotatable by being in contact with the bimetal 112 or the armature 114, and a shooter 116 configured to restrain or release a nail (not shown) of the opening/closing mechanism 107 by being restrained or released by the rotation of the crossbar 115.

Generally, when blocking of a small current is delayed, the bimetal 112 is curved by heat generated by the heater 111, and the crossbar 115 rotates to operate the opening/closing mechanism 107. When a high current is instantaneously blocked, as the armature 114 is suctioned by magnetic force excited by the magnet 113, the crossbar 115 is rotated to operate the opening/closing mechanism 107.

Manipulation force by a user is transmitted to the opening/closing mechanism 107 through the handle 107a. A pair of rotating pins 104 are installed in the opening/closing mechanism 107 to transmit power of the opening/closing mechanism 107 to each phase. The rotating pins 104 are configured to have a length crossing all phases to be installed on a shaft assembly (or a mover assembly) 120.

The base assembly 110 is disposed. A contact part and an arc extinguishing unit are installed in the base assembly 110. The base assembly 110 is disposed for each phase.

An enclosure 119 of the base assembly (briefly, base) is disposed. The base assembly enclosure 119 may be constituted as an injection-molded product. The base assembly enclosure 119 is configured to have approximately a box shape. Contact parts 105, 106, 122, and 123 and an arc extinguishing unit 150 are installed in the base assembly enclosure 119. The opening/closing mechanism 107 may be installed on the base assembly enclosure 119.

Contact parts (a fixed contactor and a movable contactor) are included. The contacts parts are parts in which a circuit is actually connected or disconnected.

The contact parts 105 and 106, i.e., fixed contactors are fixedly installed inside the enclosures 101 and 102. In detail, the fixed contactors 105 and 106 and other contact parts 122 and 123, i.e., movable contactors are installed inside the base assembly 110 included for each phase. The fixed contactors 105 and 106 are connected to the terminal parts 108 and 109.

The fixed contactors 105 and 106 are equipped with fixed contact points 105a and 106a. The fixed contact points 105a and 106a may be made of a material with excellent electrical conductivity and durability, such as a silver (Ag) alloy, etc.

In a case of a double contact point-type circuit breaker (a double circuit breaker), the fixed contactors 105 and 106 are located on a power source side and a load side, respectively. That is, the fixed contactor 105 on the power source side and the fixed contactor 106 on the load side are disposed. In this case, the fixed contactor 105 on the power source side may be directly connected to or disposed integrally with the terminal part 108 on the power source side. The fixed contactor 106 on the load side may be connected to the terminal part 109 on the load side through a trip mechanism (particularly the heater 111).

The arc extinguishing unit 150 (an arc extinguishing device or an arc chamber) is disposed in a periphery of the contact parts (the fixed contactor and the movable contactor) to extinguish an arc generated during blocking. In a case of the double circuit breaker, the arc extinguishing unit 150 is disposed on the power source side and the load side, respectively. The arc extinguishing unit 150 includes a pair of side plates 151 and 152, and a plurality of grids 160 coupled to the side plates 151 and 152 at a certain interval.

A shaft assembly 120 is disposed. A rotation pin 104 is installed through the shaft assembly 120. The shaft assembly 120 rotates by receiving opening/closing power of the opening and closing mechanism 107 by the rotation pin 104. As the shaft assembly 120 rotates, the movable contactors 122 and 123 also rotate to be in contact with or separate from the fixed contactors 105 and 106.

The shaft assembly 120 is configured to include a shaft body 121 and the movable contactors 122 and 123.

The shaft body 121 is configured to have a cylindrical shape. An axis 125 is disposed to protrude on both flat side surfaces (disk surfaces) of the shaft body 121. A pair of pinholes (no reference numeral) is disposed through the shaft body 121 in parallel to a direction of the axis 125 to allow the rotation pin 104 to inserted into the pair of pinholes.

The movable contactors 122 and 123 are rotatably equipped on the shaft body 121. The movable contactors 122 and 123 rotate counterclockwise or clockwise together with or independently of the shaft body 121 to be in contact with or separate from the fixed contactors 105 and 106 to thereby carry current to or block a line.

Movable contact points 122a and 123a that may be in contact with the fixed contact points 105a and 106a of the fixed contactors 105 and 106 are disposed on both end portions of the movable contactors 122 and 123, respectively. The movable contact points 122a and 123a may be made of a material with excellent electrical conductivity and durability, such as a silver (Ag) alloy, etc.

The movable contactors 122 and 123 rotate together with the shaft body 121 in a general small-current or high-current blocking situation. However, when current is blocked by being limited, the movable contactors 122 and 123 rotate independently due to a rapid electron repelling force. In this case, the movable contactors 122 and 123 are brought into contact with the shaft pin 125 of the shaft body 121 to stop rotating.

An arc extinguishing unit 150 is disposed to extinguish an arc generated during blocking. The arc extinguishing unit 150 is installed inside the base assembly 110. The arc extinguishing unit 150 is disposed adjacent to contact parts of the fixed contactors 105 and 106 and the movable contactors 122 and 123.

The arc extinguishing unit 150 includes the side plates 151 and 152 symmetrically facing each other to constitute a pair of side walls, and the grids 160 including a plurality of steel plates to be inserted into the side plates 151 and 152 in parallel with each other at a certain interval. The arc extinguishing unit defines an inner space by being surrounded by the side plates 151 and 152 and the grids 160, wherein an arc may be extinguished in the inner space.

When a circuit is in a normal state, the fixed contact points 105a and 106a of the fixed contactors 105 and 106 are connected to the movable contact points 122a and 123a of the movable contactors 122 and 123 so that current flows. When a fault current occurs in the circuit, the movable contactors 122 and 123 are rotated by a mechanical part 107, and the movable contact points 122a and 123a are separated from the fixed contact points 105a and 106a, thereby blocking the current. At this time, an arc occurs between the movable contact points 122a and 123a and the fixed contact points 105a and 106a. As the arc enters spaces between the grids 160, the arc is divided into short arcs to increase an arc voltage. In addition, the arc voltage further increases due to an arc extinguishing gas such as sulfur hexafluoride (SF₆) present in the arc extinguishing unit. Accordingly, as emission of free electrons is suppressed, the arc is extinguished. Then, the arc gas is discharged to outside through the exhaust part.

The arc extinguishing unit 150 includes the side plates 151 and 152 and the grids 160.

The pair of side plates 151 and 152 are disposed to be symmetrical to each other. The pair of side plates 151 and 152 may be preferably made of an insulating material. That is, the arc generated during blocking may be reflected from the side plates 151 and 152 to be collected into the grids 160.

A plurality of fitting grooves 155 and a plurality of fitting holes 156 into which the grids 160 may be coupled are disposed in the side plates 151 and 152, respectively.

The side plates 151 and 152 are equipped with coupling parts 157 and 158 into which leg portions 165 of the grids 160 are inserted.

A plurality of support plates 153 are disposed to protrude from the side plates 151 and 152 so that the grids 160 are inserted into insertion grooves 154 located between each of the support plates 153 and an adjacent support plate 153.

The grids 160 are configured to suction and extinguish an arc. In this case, a plurality of grids 160 are installed on the pair of side plates 151 and 152.

The grids 160 are configured to have a flat plate. The grids 160 are made of a steel material to help to suction the arc. The grids 160 may include a center plate part 161 and leg portions 165 extending in one direction from both ends of the center plate part 161, respectively.

A plurality of fitting protrusions 162 and 163 are disposed to protrude on both side surfaces of the center plate part 161 of the grids 160 to be installed on the side plates 151 and 152. The fitting protrusions 162 and 163 of the grids 160 are fit into the fitting holes 156 and the fitting grooves 155 in the side plates 151 and 152. In this case, caulking may be performed for stable coupling.

An entry part 164 is disposed in the grids 160 by cutting a center part of a contact part (a right portion in the drawing) of the center plate part 161. The entry part 164 is disposed to provide a space in which a contact part (a fixed contactor and a movable contactor) is located to be operated and an arc may be divided. The entry part 164 may be configured as a V-shaped groove, a U-shaped groove, etc. Accordingly, performance of arc division may be improved.

The plurality of grids 160 may be disposed and installed on the side plates 151 and 152 to have multiple layers at a certain interval. Accordingly, a passage through which an arc may pass is disposed between the grids 160. An interval at which the grids 160 are stacked may be appropriately set in consideration of division and suction force with respect to the arc.

An adsorption grid 140 is disposed to improve performance of suction of the arc and absorb dust (see FIGS. 9 and 11). The adsorption grid 140 is installed in a lower or upper portion of the base assembly enclosure 119. A fixing groove is disposed in an upper portion of the base assembly enclosure 119 so that the adsorption grid 140 is fit into the fixing groove.

An exhaust port 149 is disposed in both ends of the base assembly enclosure 119 (briefly referred to as a base). The exhaust port 149 is configured as a pipe or a hole externally connected to a part of the base 119. Particularly, the exhaust port 149 disposed on the load side is connected from the arc extinguishing unit 150 to the exhaust duct 170 outside the base 119. The exhaust port 149 is configured to have a certain length.

The terminal part mount 180 is disposed in the terminal parts 108 and 109 to connect a power or load terminal. FIG. 14 illustrates the terminal part mount 180.

The terminal part mount 180 is fit into the terminal part exhaust pipes 103. To do so, insertion grooves 181 are disposed on both side surfaces of the terminal part mount 180, respectively. The insertion grooves 181 may be preferably disposed to have a shape corresponding to an outer shape of the terminal part exhaust pipes 103. Generally, since the terminal part exhaust pipes 103 are disposed to have a rectangular cross-section, it is desirable that the insertion grooves 181 are configured to have a shape of a rectangular groove. A rib 183 protrudes from a bottom surface 182 of the terminal part mount 180 so that a support force is generated when the insertion grooves 181 in the terminal part mount 180 are inserted into the terminal part exhaust pipes 103.

A base portion 184 is disposed on the bottom surface 182 to protrude downwardly. The base portion 184 is configured to correct a clearance between the bottom surface 182 and a ground surface.

A support 185 between the insertion grooves 181 is a portion inserted between the terminal part exhaust pipes 103. In the related art, a portion of the support 185 is configured to have a closed form, and thus, a space between the terminal part exhaust pipes 103 is closed. However, in the present disclosure, the center part exhaust hole 186 connected from inside (an inner side) to outside (an outer side) is disposed in the support 185. An arc gas may be discharged through the center part exhaust hole 186. Accordingly, the arc may be discharged not only through the terminal part exhaust pipes 103 but also through the center part exhaust hole 186 in the terminal part mount 180.

A guide wall 187 is disposed above the central part exhaust hole 186 in the terminal part mount 180. A front surface portion of the guide wall 187 is disposed to be inclined to facilitate entry of an arc.

A mounting surface 188 is disposed on an upper surface of the terminal part mount 180, and a fitting groove 189 is disposed on both sides of the mounting surface 188, respectively. A terminal coupling member 190 is fit into the fitting groove 189.

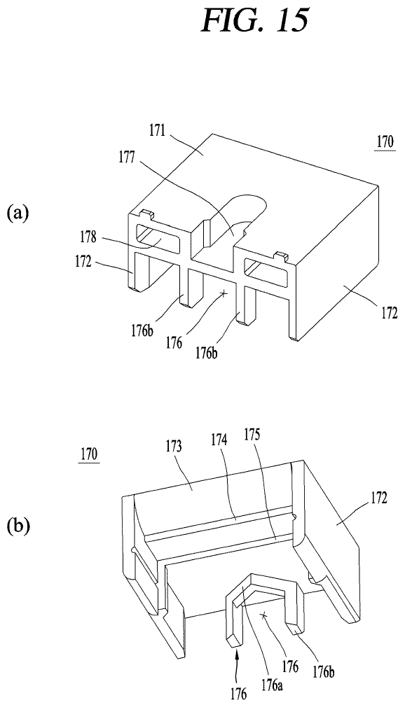

The exhaust duct 170 connecting between the exhaust port 149 in the base assembly 110 and the terminal part mount 180 is disposed. FIG. 15 is a perspective view of the exhaust duct 170.

The exhaust duct 170 connects between the exhaust port 149 on the base 119, the terminal part mount 180, and the terminal part exhaust pipes 103.

The exhaust duct 170 may be disposed to have a shape of ‘⊏’ on the whole.

One side of the exhaust duct 170 is fit into the exhaust port 149 in the base 119. Parts of an upper surface part 171 and both side surface parts 172 of the exhaust duct 170 are fit into the exhaust port 149 in the base 119. To do so, the exhaust duct 170 is configured such that a lower surface of one side of the upper surface part 171 is disposed to have a curved surface part 173, and thereafter, a first step portion 174 and a second step portion 175 are disposed. This is to increase a force of coupling with the exhaust port 149 in the base 119.

Branch ports 176a and 176b are disposed in a rear portion of the exhaust duct 170. The branch ports 176a and 176b include two leg portions 176b and a roof portion 176a connecting the two leg portions 176b. The two leg portions 176b are disposed between the exhaust hole inlet 103a of the terminal part exhaust pipes 103 and the center part exhaust hole 186 in the terminal part mount 180. A space of the rear portion of the exhaust duct 170 is divided approximately into three parts by the two leg portions 176b. That is, three arc gas discharging ports are arranged in parallel. Accordingly, an arc that occurs during blocking is divided in three directions through the leg portion 176b of the exhaust duct 170, and flows into two exhaust hole inlets 103a on both sides and the center part exhaust hole 186 between and the two exhaust hole inlets 103a.

The roof portion 176a is disposed to have a ‘V’ shape or a ‘U’ shape. This is to guide an arc mainly to the exhaust hole inlet 103a rather than the center part exhaust hole 186.

A plurality of cut grooves 177 and 172 are disposed in the upper surface part 171 of the exhaust duct 170 to reduce a weight and increase strength.

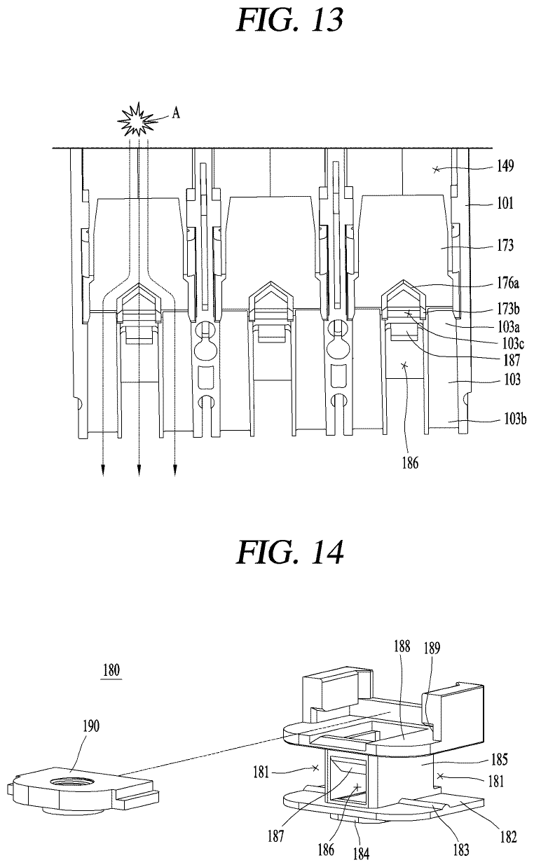

FIG. 13 illustrates an arc exhaust path in the circuit breaker according to an embodiment of the present disclosure. A path through which an arc in the exhaust port 149 in the base 119 flows out into the exhaust hole inlet 103a on both sides of each phase is identical to that disclosed in the related art. As an arc discharging path newly added to the present disclosure, the present disclosure discloses a path in which an arc from the exhaust port 149 in the base 119 flows into the center part exhaust hole 186 in the terminal part mount 180 via the through hole 103c between the exhaust hole inlets 103a on both sides of each phase and the center part exhaust groove 176 in the exhaust duct 170. That is, an arc discharging path is expanded from two spaces to three spaces for each phase, and there is almost no blocked portion in a space of the exhaust port.

In other words, an arc gas may be discharged to outside through the terminal part exhaust pipes 103 and the central exhaust hole 186 with almost no closed portion (a portion subject to resistance) in a path through which the arc gas flows from the exhaust port 149 in the base 119 to outside.

In the circuit breaker according to one embodiment of the present disclosure, an exhaust passage for discharging an arc gas is further disposed between terminal part exhaust pipes, thereby preventing a delay in discharging exhaust pressure.

A through hole is disposed in a partition wall portion between terminal part exhaust pipes to communicate with a center part exhaust groove in an exhaust duct and a center part through hole in a terminal part mount. Accordingly, a center part arc discharging path between exhaust pipes may be defined.

When arc gas flows out of an exhaust port in a base assembly, a portion closed until the arc gas is discharged to outside is minimized. Thus, discharging may be facilitated without waste of a space.

Accordingly, a phenomenon in which the arc gas stagnates in the exhaust port may be reduced.

Accordingly, a phenomenon in which a pressure increases in a product may be prevented, and a damage to an enclosure for the product may be prevented.

The embodiments described above are intended to implement the present disclosure, and it will be understood by one of ordinary skill in the art that various changes in form and details may be made therein without departing from the spirit and scope of the present disclosure. Accordingly, the embodiments described therein should be considered in a descriptive sense only and not for purposes of limitation, and the scope of the technical idea of the present disclosure is not limited by these embodiments. That is, the scope of protection of the present disclosure should be interpreted in accordance with the appended claims, and all technical ideas within the scope will be construed as being included in the scope of the present disclosure.

1. A circuit breaker comprising:
an enclosure for the circuit breaker;
a base assembly installed in the enclosure for each phase;
an exhaust duct connected to an exhaust port in the base assembly; and
a terminal part mount coupled to a terminal part of the enclosure and connected to the exhaust duct,
wherein a center part exhaust groove is disposed in the exhaust duct, and
a center part exhaust hole communicating with the center part exhaust groove is disposed through the terminal part mount.

2. The circuit breaker of claim 1, wherein a pair of terminal part exhaust pipes through which an arc gas is discharged are disposed in the terminal part for each phase,
the terminal part mount comprises a support disposed between the pair of terminal part exhaust pipes, and
the center part exhaust hole directing from inside toward outside of the enclosure is disposed in the support.

3. The circuit breaker of claim 2, wherein the enclosure is equipped with a through hole disposed in a partition wall between the pair of terminal part exhaust pipes.

4. The circuit breaker of claim 1, wherein a guide wall having a curved front surface part is disposed above the central part exhaust hole.

5. The circuit breaker of claim 1, wherein a portion of an upper surface of the exhaust duct, the portion being connected to the exhaust port, is disposed as a curved surface portion.

6. The circuit breaker of claim 5, wherein, after the curved surface portion is disposed, a first step portion and a second step portion a portion are disposed on the upper surface of the exhaust duct.

7. The circuit breaker of claim 1, wherein a branch port having two leg portions is disposed in a rear portion of the exhaust duct, and
a space between the two leg portions is the center part exhaust groove.

8. The circuit breaker of claim 1, wherein a roof portion having a ‘V’ shape or a ‘U’ shape is disposed on the two leg portions.

9. The circuit breaker of claim 1, wherein a plurality of cut grooves are disposed in an upper surface part of the exhaust duct.

10. A circuit breaker comprising:
an enclosure;
a base assembly comprised in the enclosure for each phase;
an exhaust duct connected to an exhaust port in the base assembly; and
a terminal part mount coupled to a terminal part of the enclosure and connected to the exhaust duct,
wherein a through hole is disposed between a pair of terminal part exhaust pipes located on the terminal part,
a center part exhaust groove communicating with the through hole is disposed in the exhaust duct, and
a center part exhaust hole communicating with the center part exhaust groove is disposed through the terminal part mount.
